(19) United States
(12) Patent Application Publication
(10) Pub. No.: US 2008/0086474 A1
(43) Pub. Date: Apr. 10, 2008

(54) System for providing data to third party users

(76) Inventors: Christine M. Haycraft, Norman, OK (US); Dawn D. Hallman, Norman, OK (US)

Correspondence Address: DUNLAP CODDING & ROGERS, P.C., PO BOX 16370, OKLAHOMA CITY, OK, 73113, US

(21) Appl. No.: 11/544,385

(22) Filed: Oct. 6, 2006

(51) Int. Cl. G06F 17/30

(52) U.S. Cl. 707/9

(57) ABSTRACT

A member to user information system that makes a person's vital information readily available to third party users when that person is not available. The member to user information system includes an interface system, a storage system, and a verification system. The interface system allows multiple non-administrative members to individually enter sets of member entered information and to create user privileges for specific third party users that relate to the sets of member entered information. The interface system allows the specific third party users to retrieve the member entered information according to the member created user privileges. The storage system stores the member entered information. The verification system validates the users that are allowed to access the member entered information.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAMMING LISTING APPENDIX SUBMITTED ON A COMPACT DISC AND AN INCORPORATION-BY-REFERENCE OF THE MATERIAL ON THE COMPACT DISC

Not Applicable.

### BACKGROUND OF THE INVENTION

In many situations it is vital to find out specific information about a person. Such information relates to the person's food allergies, medical allergies, emergency contact, third party making medical decisions, will information and the like. If the person were available, then such information would be readily available. On the other hand, such information is usually vital in a situation where the person is unconscious or unavailable to produce such information. Therefore, there is a need for a system that would be readily and easily available to produce vital personal information to persons or institutions.

Currently, vital information about a person's health can be engraved onto tags that can be worn on ones person. Some individuals carry such information on a USB portable memory which can be carried on a key-chain. The problem with such solutions is that the information is available to the public without the ability to restrict or to classify third party access. In addition, the tags and the USB portable memory are carried on one's person; thus, both solutions can be easily misplaced or lost. Therefore, there is a need for a solution that would allow the information to be viewed on a need basis, and a solution that would not be lost or misplaced.

### BRIEF SUMMARY OF THE INVENTION

The present invention relates to a member to user information system that makes a person's vital information readily available to a third party when that person is not available. The member to user information system includes an interface system, a storage system, and a verification system. The interface system allows multiple non-administrative members to individually enter sets of member entered information and to create user privileges for specific third party users that relate to the sets of member entered information. The interface system allows the specific third party users to retrieve the member entered information according to the member created user privileges. The storage system stores the member entered information. The verification system validates the users that are allowed to access the member entered information.

In another aspect, the present invention relates to a process of servicing a member to user information system. In this aspect, the process includes the steps of operating the member to user information system; creating a member account; processing member's requests; verifying members and users accessing the member to user information system; allowing members to store in a storage system of the member to user information system a member entered information; maintaining the storage system that includes the members' information; allowing non-administrative members to create users' accounts and define users' privileges; and allowing users to access the member entered information according to the non-administrative member defined user's privileges.

### BRIEF DESCRIPTION OF THE SEVERAL VIEWS OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and therefore not to be considered limiting of its scope, for the invention may admit to other equally effective embodiments.

FIG. 1 is a schematic view of a member to user information system constructed in accordance with one embodiment of the present invention.

FIG. 2. is a flow diagram illustrating an exemplary registration process for registering a new member with the member to user information system.

FIG. 3. is a flow diagram illustrating an exemplary editing process for editing the member entered information of the member to user information system.

FIG. 4. is a flow diagram illustrating an exemplary process for a third party user accessing the member to user information system.

### DETAILED DESCRIPTION OF THE INVENTION

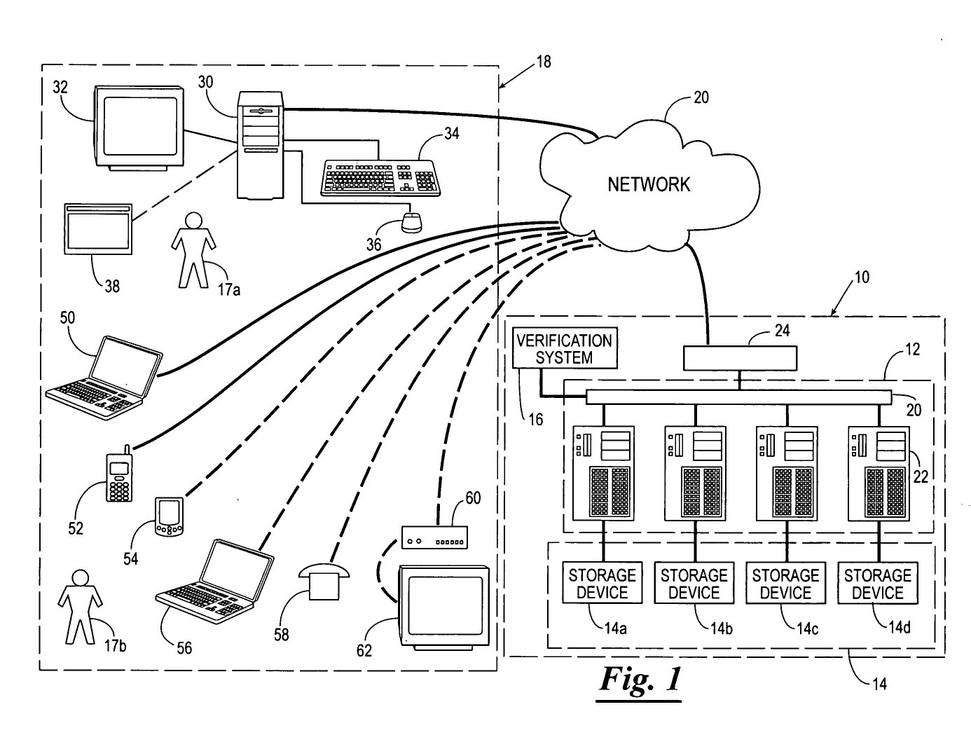

Referring now to the drawings, and in particular to FIG. 1, shown therein and designated by a reference numeral 10 is an embodiment of a member to user information system constructed in accordance with the present invention. In general, the member to user information system 10 is provided with an interface system 12, a storage system 14, and a verification system 16. The interface system 12 allows multiple non-administrative members 17a to individually enter sets of member entered information and create user privileges for third party users 17b that relate to the sets of member entered information. The interface system 12 allows the third party users 17b to retrieve the member entered information according to the member created user privileges. The storage system 14 stores the member entered information. The verification system 16 validates the third party users 17b that are allowed to access the member entered information.

In general, FIG. 1 is an exemplary hardware diagram for the system 10. The member to user information system 10 communicates with one or more user devices 18 via a network 20. The network 20 can be Internet or other network. The interface system 12 typically includes one or more servers 22 configured to communicate with the network 20 using one or more gateways 24. When the network 20 is the Internet, the interface system 12 of the member to user information system 10 typically uses a series of web pages. However, it should be understood that the interface system 12 can be replaced by another type of interface, such as a Windows-based application. This method can also be used when the user devices 18 are located in a stand-alone or non-portable environment such as a kiosk.

The network 20 can be almost any type of network although the Internet and Internet 2 networks are preferred because of the wide support of their underlying technologies. The preferred embodiment of the network 20 exists in an Internet environment, which means a TCP/IP-based network. It is conceivable that in the near future, the preferred or other embodiments, may wish to use more advanced networking topologies. In addition, the network 20 does not refer only to computer-based networks but can also represent telephone communications or any other communications.

The servers 22 can be networked with a network 26, such as, a local area network or a wide area network. The gateway 24 is an entity or device responsible for providing access between the network 26 and the network 16. The gateway 24 can also be used as a security means to protect the network 26 from attack from an external network such as the network 20.

The network 26 can be based on a TCP/IP network such as the Internet, or can be based on another underlying network transport technology. The preferred embodiment uses an Ethernet network with TCP/IP because of the availability and acceptance of underlying technologies, but other embodiments may use other types of networks such as Fiber-Channel, SCSI, gigabyte Ethernet, etc.

As discussed above, in one preferred embodiment, the interface system 12 includes the servers 22. The configuration of the hardware for the servers 22 will depend greatly upon requirements and needs of the particular embodiment of the system 10. Typical embodiments, including the preferred embodiment, will include multiple servers 22 with load-balancing to increase stability and availability. It is envisioned that the servers 22 can access the storage system 14, and the verification system 16.

The interface system 12 is preferably configured as a web-site that guides members 17a and third party users 17b through the system 10 to assist them in storing and retrieving information. The storage system 14 is preferably, but is not limited to, a database. The storage system 14 can include multiple storage devices. For example, four storage devices are shown in FIG. 1 and designated by reference numbers 14a, 14b, 14c, and 14d for purposes of clarity. The storage devices 14a-d can be magnetic or optical devices, memory, tape, or other types of storage mediums as well as local or remote storage controllers. The information is stored and made available for retrieval by the storage system 14. The verification system 16 validates the third party users 17b and members 17a that are allowed to access, edit, remove, or add information to the member entered information. The verification system 16 could use, but is not limited to, unique identification numbers or names, passwords, fingerprints, or identification cards, such as magnetic or digital cards.

The third party users 17b and members 17a can access the information on the storage system 14 via any of the devices 18. The devices 18 can be implemented in a variety of different manners. For example, in one scenario, a member 17a or a third party user 17b, uses a computer 30 with a monitor 32, a keyboard 34, and a mouse 36. In the preferred embodiment, the member 17a or third party user 17b is required to use a type of software called a “browser” as designated by a reference numeral 38. The browser 38 is used to render content that is received from a source, such as the servers 22. In the modern vernacular, a “browser” refers to a specific implementation called a Web browser. Web browsers are used to read and render HTML/XHTML content that is generated when requesting resources from a web server. In the preferred embodiment, the member to user information system 10 is designed to be compatible with major Web browser vendors such as Microsoft Internet Explorer, Netscape Navigator and Opera. However, other embodiments may wish to focus on one particular browser depending upon the common user base connecting to the servers 22.

The user devices 18 can also be implemented as a portable device such as a laptop computer 50 (or handheld computer); a cellular telephone 52 with a micro or embedded Web browser; a portable digital assistant 54 (PDA) capable of wireless network access; a pen-based or tablet computer 56. In another embodiment, the user device 18 can be a cable-television box 60 or other similar device, such as a, a telephone 58, or a Web TV, for viewing through a monitor 62 or television. Current embodiments of the system 10 can also be modified to use any of these or future developed devices.

The member to user information system 10 is designed in this way as to provide flexibility in its deployment. Depending upon the requirements of the particular embodiment, the engine could be designed to work in almost any environment such as a desktop application, a Web based application, or simply as a series of Web services designed to communicate with an external application.

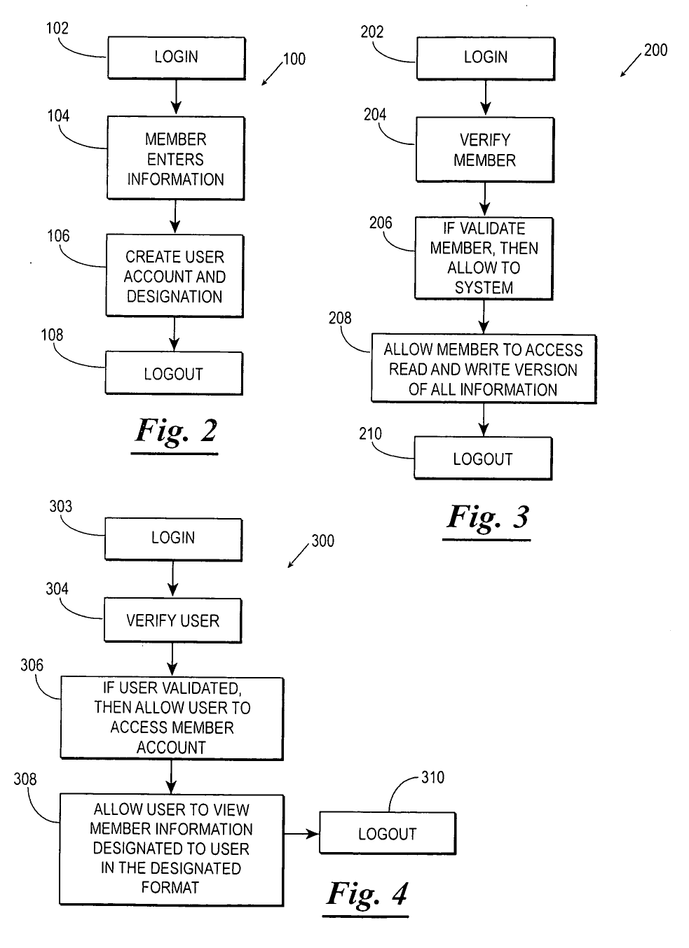

Referring to FIG. 2, a flow diagram illustrates an exemplary process for registering a new member. The process 100, initially preferably includes a login step 102. In the login step 102, the interface system 12 requests personal information from the member; such as, username, address, telephone number, password, age and the like. The member provides the personal information and the interface system 12 stores the personal information so that such personal information can be accessed by the verification system 16. The login information from step 102 is used to create a member account that the member 17a can access. The process 100 then branches to a step 104. In the step 104, the member 17a enters various information that the member 17a wishes to make available to the third party users 17b through the member to user information system 10. The interface system 12 stores the member entered information from step 104 under the member created account created during step 102 in one or more of the storage devices 14a-d of the member to user system 10. Such information includes, but is not limited to, medical related information, such as rescue forms, emergency information, food and drug allergies, power of attorney forms, living wills, and the like. The process 100 then proceeds to step 106. In step 106 the member creates third party user accounts and/or selects predefined third party user accounts and designates or creates user privileges for each third party user 17b or groups of third party users 17b, such as health care providers or hospitals. The third party users 17b can retrieve the member entered information according to the member created user privileges. The member 17a can designate which documents would be available for specific third party users' viewing. The member 17a can allow third party users 17b to view read-only version of some documents, allow them to read and edit other documents, and combinations thereof. The member entered information may be uploaded into the storage system 14 of the member to user information system 10 at a single time, or multiple different times. For example, the information can be uploaded into the storage system 14 simultaneously as the member 17a enters the information, at different interval of time, or at the end after the member 17b enters all the information, or at any other time setup for uploading. The process 100 then continues to optional step 108 where the member 17a may or may not choose to logout of the member to user information system 10. For example, the member to user information system 10 may automatically logout the member 17a if inactivity persists for a pre-determined amount of time or other reason.

The member 17a can also edit the information entered through the registration process 100. The member entered information editing process 200 is shown in FIG. 3. The process 200 initially preferably includes a login step 202 where the member 17a uses the account information setup in registration process 100 to log back into the member to user information system 10. The process then flows into step 204. In step 204, the verification system 16 validates the member 17a (or the user device 18 that the member 17a is using) by way of username, password, access code, IP address or the like. If the validation is successful, the process continues to step 206 and the member 17a can access the member entered information from process 100 stored in the storage system 14. The process 200 continues to step 208 where the member accesses the information in his account and is able to read, edit, and remove information stored in the storage system 14 of the member to user information system 10. The changes can be uploaded into the storage system 14 of the member to user information system 10 simultaneously or at a different time. For example, the information can be uploaded into the storage system 14 simultaneously as the member 17a enters the information, at different interval(s) of time, or at the end after the member enters all the information, or at any other time setup for uploading. Thereafter, the process 200 branches to a step 108 where the member 17a is logged out, either automatically by the system 10 or manually.

FIG. 4 illustrates a flow diagram for a process 300 where a third party user 17b accesses the member entered information of a specific member of the member to user information system 10. Most likely, third party users 17b would need to access members' information when the member 17a is in an emergency situation or the member 17a is unavailable, such as after the member 17a has passed away. On the other hand, the member 17a may make information readily available to the third party users 17b in non-emergency situations, i.e. for doctor visits.

The process 300 initially preferably includes a login step 302. In the login step 302, the third party user 17b logs into a specific member account using the user account that the member created. To access the member's account 300, the third party user 17b must use the validation mechanism that the member setup for that specific user. For example, a third party user 17b, such as a hospital may be validated using the members biometrics fingerprint or the hospital's IP address, where as a different third party user 17b, such as a family member may use a user name, while another different third party user 17b, such as a member's attorney may use a bar code. The third party user's validation is preferably designated by the member 17a and may be individual to each specific third party user 17b. The process 300 continues to the verification step 304. In the verification step 304, the verification system 16 validates the third party user 17b. The verification system 16 typically compares the third party user 17b entered login information with the member entered user account information to validate the third party user 17b, although other methods can be used. It is preferable that the verification system 16 allows the third party user 17b to access the member account if the third party user 17b entered login information and the member created user account information correspond in a predetermined manner. In the preferred embodiment, the process 300 continues to step 306 if the verification system 16 validates the user. In step 306, the third party user 17b is allowed to access the member account and to select documents and information loaded by the member 17a onto the member to user information system 10. The third party user 17a may or may not be able to see that there are other documents that are not designated to that specific third party user 17b. It is desirable to allow the third party user 17b to select only the documents that the member 17a designated for that third party user 17b. The process 300 proceeds to step 308. In step 308, the third party user 17b views the documents designated to that specific third party user 17b by the member 17a. The format that the documents are viewed by the third party user 17b is preferably the format that the member 17a designated for that specific third party user 17b. For example, a third party user 17b may only be able to view documents in read only mode if the member 17a so designated; on the other hand, that third party user 17b may be able to view other documents in read and write format. The same document can be designated as a read only format to one third party user 17b and as a read and write format to another third party user 17b. The process 300 may continue to optional step 108. The third party user 17b may or may not choose to continue to step 108 to logout of the member to user information system 10. The member to user information system 10 may automatically logout a third party user 17b if inactivity persists for a pre-determined amount of time or other reason.

### EXAMPLE

In one embodiment, the system 10 is implemented as a website that allows a person (member 17a) to store various types of personal data, including vital information regarding an individual's emergency contact, food and drug allergies, and other documents reflecting their choice to one or more third party users 17b. For example, information that would assist a third party user 17b in making medical decisions and choices regarding life support and resuscitation.

In one preferred embodiment, the website saves and retrieves personal information about a person. For example, the web-site could be used when an unconscious person comes into a hospital, e.g. member 17a, and have his fingerprints scanned with a biometrics reader. The hospital computer (user device 18), while logged onto the web-site, will submit the biometrics scan of the fingerprint to validate the hospital computer and permit the health care provider to access documents (member entered information) desirably subject to the user privileges set up by the member 17. The storage system 14 can include multiple sequel database servers that will search through records of fingerprints to determine who the individual is, who should be contacted (emergency contact), allergies, medical wishes, and important documents (Power of Attorney, Living Will, a certified Do Not Resuscitate Form, etc.). This information will be provided accurately and timely to the hospital or any other third party user designated by that person; such as, showing such information on the hospital's by that person; such as, showing such information on the hospital's screen or third party user's computer, or allowing the hospital or third user to print a copy of such information.

To setup such a service, a member/client 17a logs onto the web-site to setup an account. The web-site permits the member 17a to designate persons (third party users 17b) with access to their account through a user name and password, or the like. Some of these designated persons would be identified by an IP address, i.e. a hospital and first aid respondents. The access gained by third party users 17b would be a “read only” format of the member's information. In addition, the web-site is set up to permit the member to be able to edit the account's information. It is preferred that all legally executed documents would be authenticated for originality.

The level of access to third party users 17b preferably varies from one third party user to another third party user depending on the member's 17a wishes. If access has been pre-authorized by a member 17a, certain entities and individuals (i.e. hospitals and first responders) with verifiable IP addresses can access the member's information. For example, the hospital can use the web-site to log onto the system 10. The hospital will use a unique identifier provided by the individual (such as bar codes, IP address, user identifications, passwords, or biometrics fingerprinting) to ensure that the hospital is reading the proper credentials. The web-site will then typically use several consecutive searches and validations to locate that specific client's information in the database. The hospital will then have access to the documents that the member 17a approved the hospital to view. For example, the client may pre-approve the hospital to view emergency contact, medical history, and allergies, but not allow the hospital to view a will or the like.

From the above it is clear that the present invention is well adapted to carry out the object and to attain the advantages mentioned herein as well as those inherent in the invention. While more specific embodiments of the invention have been described for purposes of this disclosure, it will be understood that numerous changes may be made which will readily suggest themselves to those skilled in the art and which are accomplished within the spirit of the invention disclosed and defined in the appended claims

What is claimed is:

1. A member to user information system comprising of:
an interface system allowing multiple non-administrative members to individually enter sets of member entered information and create user privileges for specific users that relate to the sets of member entered information, the interface system allowing the specific users to retrieve the member entered information according to the member created user privileges;
a storage system storing the member entered information;
a verification system validating the users that are allowed to access the member entered information.

2. The member to user information system of claim 1, wherein the user interface allows the member to edit the member entered information.

3. The member to user information system of claim 1, wherein the user interface restricts the user to view a read only version of the member entered information.

4. The member to user information system of claim 1, wherein the storage system is a database.

5. The member to user information system of claim 1, wherein the interface system is accessible via the internet.

6. The member to user information system of claim 1, wherein the verification system accesses unique codes to validate the member.

7. The member to user information system of claim 1, wherein the verification accesses unique codes to validate the users.

8. The member to user information system of claim 1, wherein the member created user privileges determine the type of information and the type of access a user can utilize on the member entered information.

9. The member to user information system of claim 1, wherein the storage system is wirelessly connected to the verification system.

10. The member to user information system of claim 1, wherein the storage system and the verification system are in different locations.

11. The member to user information system of claim 1, wherein the storage system is centralized in a single location.

12. The member to user information system of claim 1, wherein the storage system is distributed over 2 or more systems.

13. The member to user information system of claim 1 further comprising a billing system cooperating between the member to user information system and the members.

14. The member to user information system of claim 1, wherein the member information is entered by an operator dealing with the member as a customer.

15. The member to user information system of claim 1 further comprising of a messaging system that notifies users and members about member's information and updates.

16. A process of servicing a member to user information system, comprising:
operating the member to user information system;
creating a member account;
processing member's requests;
verifying members and users accessing the member to user information system;
allowing members to store in a storage system of the member to user information system a member entered information;
maintaining a storage system that includes the members' information;
allowing the non-administrative members to create users' accounts and define users' privileges; and
allowing users to access the member entered information according to the non-administrative member defined user's privileges.
